(19) United States
(12) Patent Application Publication
(10) Pub. No.: US 2015/0354690 A1
(43) Pub. Date: Dec. 10, 2015

(54) SYSTEM AND METHOD FOR MONITORING PRELOAD IN BALL SCREW

(71) Applicant: HIWIN TECHNOLOGIES CORP., TAICHUNG CITY (TW)

(72) Inventors: CHIH-CHUN CHENG, Tainan City (TW); PING-CHUN TSAI, Taipei City (TW); WEN-NAN CHENG, Tainan City (TW); HUNG-CHUN HUANG, Kaohsiung City (TW); KAI-HUNG LO, Taipei City (TW); CHI-RUNG LI, Changhua City (TW); TENG-DER TSAI, Taipei City (TW); FU-CHING WANG, Taichung City (TW); FU-HAN XU, Tainan City (TW)

(21) Appl. No.: 14/476,153

(22) Filed: Sep. 3, 2014

(30) Foreign Application Priority Data
Jun. 4, 2014 (TW) 103119410

(51) Int. Cl. F16H 57/01; G01N 29/14; G01N 29/46; F16H 25/22

(52) U.S. Cl. CPC F16H 57/01; F16H 25/2204; G01N 29/14; G01N 29/46; F16H 2057/012; G01N 2291/014; G01N 2291/023

(57) ABSTRACT

A system for the monitoring a preload in a ball screw includes a ball screw, a detecting device, a capturing device and a processing device. The ball screw has a preload. The detecting device detects an operating signal of the ball screw. The operating signal contains information about the ball screw's rotating speed and status. The status refers to a vibration or a sound generated by the operating ball screw. The capturing device is connected to the detecting device and acquires the operating signal. The processing device is connected to the capturing device, and has a threshold. The processing device processes and converts the operating signal into a ball-passing signal. When the ball-passing signal surpasses the threshold, the processing device determines that the ball screw's preload has vanished. Thereby, the system is enabled to determine the current state of the ball screw's preload reliably.

### BACKGROUND OF THE INVENTION

1. Technical Field

The present invention relates to technology of determining service life of ball screws, and more particularly to a system and a method for monitoring a preload in a ball screw.

2. Description of Related Art

With the development of the machine tool industry, the requirement set for machine tools' accuracy of positioning is increasingly higher. Therein, ball screws are commonly used transmission elements that feature for high accuracy, long service life and high-speed forward and backward transmission.

Generally, before delivering a ball screw, the manufacturer applies a preload to the ball screw according to the buyer's need, so as to eliminate the axial backlash of the ball screw, and ensure the ball screw's accuracy of positioning and rigidity.

However, after a long term of use, the ball screw tends to have its screw, balls and nut get worn, and as a result, the ball screw can have axial backlash, both decreasing the ball screw's preload, and in turn reducing the ball screw's accuracy of positioning and rigidity.

As stated above, the ball screw's preload exists inside the ball screw and is not accessible and measurable to an external measuring device. Generally, the preload loss can be determined by measuring the preload drag torque through the torque sensor or the force gauge while the ball screw in operation. However, the pricey torque sensor makes it impractical to be an on-line preload loss monitoring sensor. Taiwan Patent No. 1400438 discloses a detecting device of a transmission element, which determines whether a preload exists in a ball screw by measuring frequency in which the balls pass through a Hall IC during a unit time (i.e. the balls' ball-passing frequency), and using a comparing device to compare the measured ball-passing frequency with a preset ball-passing frequency.

Taiwan Patent No. I407026 discloses a diagnosis method of ball screw preload loss via Hilbert-Huang transform and apparatus therefore, wherein Hilbert-Huang transform is used to generate a multi-scale entropy complexity model for the diagnosis of the lead ball screw's preload.

### SUMMARY OF THE INVENTION

The primary objective of the present invention is to provide a system and a method for monitoring a preload in a ball screw, which involve detecting vibration or sound of the ball screw's balls and accordingly determining whether ball screw's preload has vanished, thereby monitoring the preload loss reliability.

Fir achieving the foregoing objective, the disclosed system comprises a ball screw, a detecting device, a capturing device and a processing device. The ball screw has a preload. The detecting device detects an operating signal of the ball screw. The operating signal contains information about the ball screw's rotating speed and status. The status refers to a vibration or a sound generated by the operating ball screw. The capturing device is connected to detecting device, and acquires the operating signal. The processing device is connected to capturing device, and has a threshold. The processing device processes and converts the operating signal into a ball-passing signal, and determines the ball screw's preload has vanished when the ball-passing signal surpasses the threshold.

The disclosed method comprises the following steps: a detecting device that detects an operating signal of a ball screw in operation, wherein the operating signal contains information about the ball screw's rotating speed and status, and the status refers to a vibration or a sound generated by the operating ball screw, in which the ball screw comprises a plurality of balls and at least one return tube, and the balls pass through the return tube; a capturing device acquiring the operating signal; a processing device receiving and analyzing the operating signal, and having a threshold; the processing device performing an order tracking process, which involves analyzing the operating signal, so as to track a ball-passing frequency order that is associated with the ball screw's balls revolution speed; the processing device performing a ball-passing frequency order analysis, and identifying a corresponding ball-passing signal according to the ball-passing frequency order; and the processing device determining that the ball screw's preload has vanished when the ball-passing signal surpasses the threshold, and determining that the ball screw's preload has not vanished when the ball-passing signal has not surpassed the threshold.

Thereby, the disclosed system and method can monitor the ball screw's preload more accurately as compared to the prior art.

The following preferred embodiments when read with the accompanying drawings are made to clearly exhibit the above-mentioned and other technical contents, features and effects of the present invention. Through the exposition by means of the specific embodiments, people would further understand the technical means and effects of the present invention adopted to achieve the above-indicated objectives. However, the accompanying drawings are intended for reference and illustration, but not to limit the present invention and are not made to scale.

### BRIEF DESCRIPTION OF THE DRAWINGS

FIG. 1 is a bloc diagram of a system for monitoring a preload in a ball screw according to the present invention.

FIG. 2 is a flowchart of a method for monitoring a preload in a ball screw according to the present invention.

FIG. 3 graphically shows the monitoring result obtained using the system of FIG. 1 and the method of FIG. 2.

FIG. 4 is a flowchart of an order tracking process in the method of FIG. 2.

### DETAILED DESCRIPTION OF THE INVENTION

For further illustrating the means and functions by which the present invention achieves the certain objectives, the following description, in conjunction with the accompanying drawings and preferred embodiments, is set forth as below to illustrate the implement, structure, features and effects of the subject matter of the present invention without limitation.

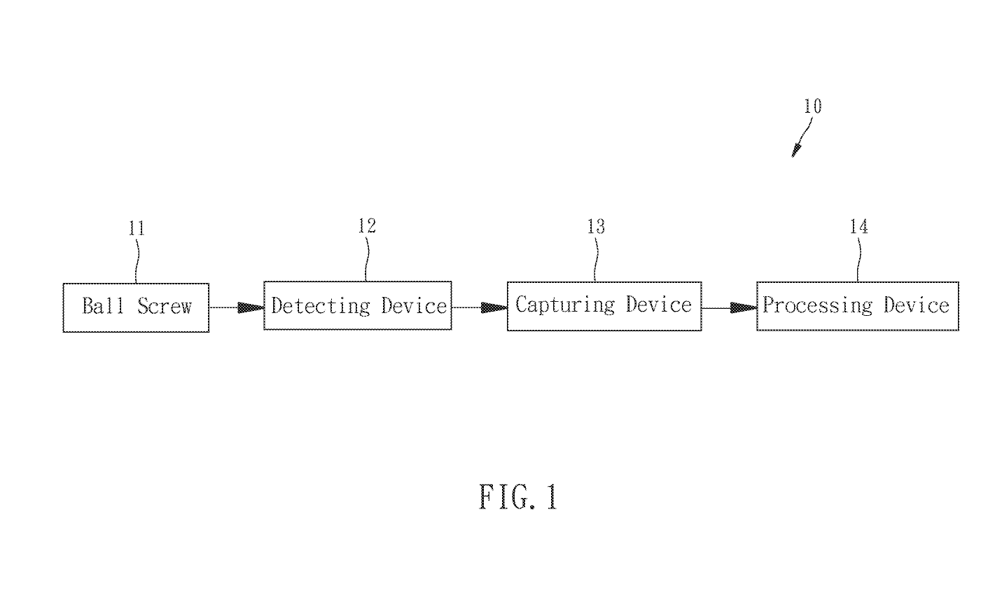

Referring to FIG. 1, in a system for monitoring a preload in a ball screw as disclosed, the system 10 comprises a ball screw 11, a detecting device 12, a capturing device 13 and a processing device 14. Therein, a ball screw like the illustrated one 11 is extensively used and the structure and operation thereof are known in the art. The ball screw 11 may be of an external-circulation type, an internal-circulation type or a cover-circulation type. In any of the above cases, the ball screw 11 has a screw, a nut, a plurality of balls and at least one return tube. When the ball screw 11 operates, the balls move between the screw and the nut while passing through the return tube. All these are known in the art, and thereof no further discussion is given thereto.

The detecting device 12 detects an operating signal of the ball screw 11. The operating signal contains information about a rotating speed and a status of the ball screw 11. The status refers to a vibration or a sound generated during the operation of the ball screw 11.

The capturing device 13 is connected to the detecting device 12, and acquires the operating signal.

The processing device 14 is connected to capturing device 13, and has a threshold. It processes and converts the operating signal into a ball-passing signal, and determines that the ball screw's preload has vanished when the ball-passing signal surpasses the threshold.

The previous description relates to the disclosed system 10 and its key components as well as their functions. With the configuration, the disclosed system 10 is able to effectively monitor the preload in the ball screw 11. What is to be discussed in detail below is the method used to monitor the ball screw's preload.

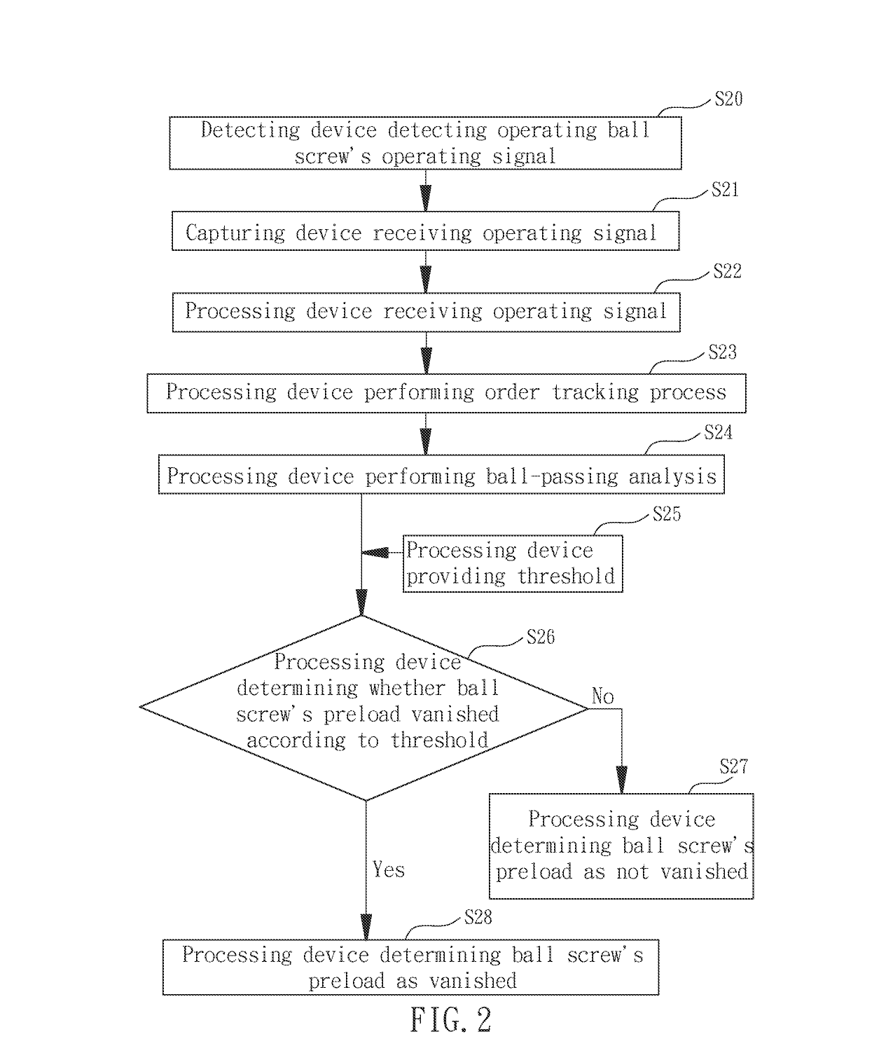

Referring to FIG. 2, according to the present invention, the method comprises the following steps:

Step S20, a detecting device detecting an operating signal of the ball screw that is operating;

Step S21, a capturing device acquiring the operating signal;

Step S22, a processing device receiving the operating signal;

Step S23, the processing device performing an order tracking process, which involves analyzing the operating signal, so as to track a ball-passing frequency order that is associated with a revolution speed of the ball screw' balls;

Step S24, a processing device performing a ball-passing frequency order analysis, which involves identifying a corresponding ball-passing signal according to the ball-passing frequency order;

Step S25, the processing device providing a threshold;

Step S26, the processing device determining whether the ball screw's preload has vanished according to the threshold;

Step S28, the processing device determining that the ball screw's preload has vanished when the ball-passing signal surpasses the threshold; and

Step S27, the processing device determining that the ball screw's preload has not vanished when the ball-passing signal has not surpassed the threshold.

Thereby, the disclosed method is applicable to a ball screw that is operating to use the detecting device to directly detect the operating signal, and the capturing device can transmits the operating signal it receives to the processing device, so as to allow the processing device to perform processing, analysis and determination (i.e. Steps S22-S28).

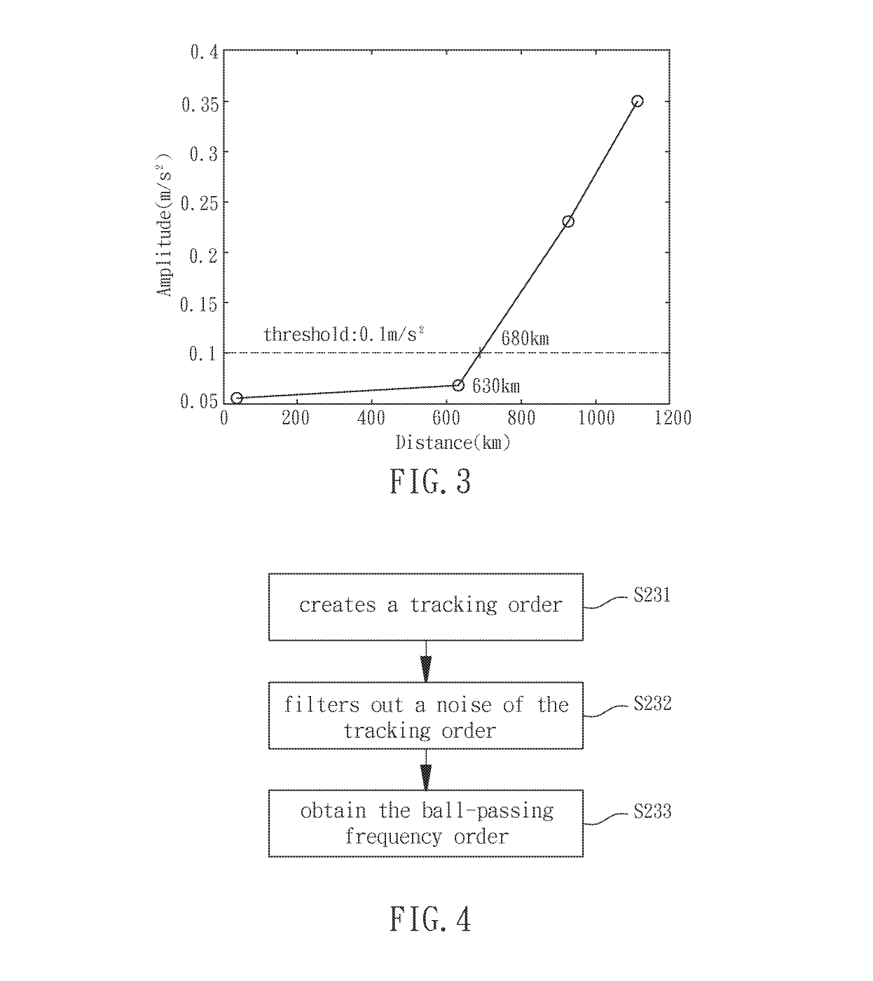

During the process where the ball screw operates for a period of time or for a certain distance, the detecting device keeps performing Step S20, and the capturing device keeps performing Step S21, while the processing device keeps performing Steps S22-S28. Thus, the disclosed system and method can get the result as shown in FIG. 3. In the graphic, the horizontal axis represents the distance the ball screw operates in kilometer (Km), and the vertical axis represents the ball screw' vibration at the ball pass frequency, or simply called ball pass vibration hereafter. As shown, after the first 630 km the ball screw runs, the ball-passing vibration starts to increase sharply. This indicates that wearing between the ball screw's shaft, balls and nut has formed axial backlash in the ball screw, and in turn makes the ball screw's preload to decrease significantly, but not to the extent where the ball screw becomes unusable. The ball-passing signal at this moment has not surpassed the threshold (the dotted line in the graphic), which in the present embodiment is set as 0.1 m/s². In practice; however, the threshold may be set differently according to the need of the ball screw, and is not limited to 0.1 m/s².

After the running distance of the ball screw exceeds 680 km, the ball-passing signal has surpassed the threshold, which means that the processing device determines that the ball screw's preload has vanished. While the ball screw is determined as having its preload vanished, the ball screw's preload is in fact not becoming zero, yet this state refers to that the residual preload is not sufficient for the ball screw's normal operation, and the related components need to be replaced.

Referring to FIG. 4, the order tracking process (Step S23) further comprises the steps as described below.

The processing device creates a tracking order (Step S231), and filters out a noise of the tracking order (Step S232), so as to obtain the ball-passing frequency order (Step S233). Creating the tracking order involves building a structural equation and a data equation in the processing device, and filtering out the noise involves using the structural equation and the data equation to isolate the tracking order's noise. At last, a mathematical optimization method is built in the processing device (such as the least square method), for filtering out the noise and allowing the ball-passing signal to be more close to the vibration or sound of the ball screw. In other words, the processing device can filter out any noises other than the ball's vibration or sound, so as to enhance the accuracy of preload monitoring.

As stated above, the ball-passing frequency order is associated with the balls' revolution speed, and the ball-passing signal is associated with the vibration or sound generated by the balls, while the noise refers to the vibration or sound generated by other than the ball screw's balls. To state differently, the ball-passing signal is associated with the balls, and the noise is the vibration or sound generated by an element (such as the screw and the nut) nut not by the balls.

Particularly, while the operating signal in the previously-discussed preferred embodiment contains the information about the ball screw's rotating speed and running status (i.e. vibration), it may further contain information about the noise generated by the operating ball screw, by which the preload-monitoring accuracy of the ball screw can be further enhanced.

To sum up, different from the prior art, the disclosed system and method can eliminate the interferences caused by other source of vibrations or sounds than the balls, so as to accurately monitoring the preload by directly referring to the vibration or sound of the balls of the ball screw.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A system for monitoring preload in a ball screw, the system comprising:
a ball screw, having a preload;
a detecting device, detecting an operating signal associated with the ball screw, the operating signal contains information about a rotating speed and a status of the ball screw, the status refers to a vibration or a sound generated by the operating ball screw;
a capturing device, being connected to the detecting device, and acquiring the operating signal; and
a processing device, being connected to the capturing device, having a threshold, serving to process convert the operating signal into a ball-passing signal, and determining that the preload of the ball screw has vanished when the ball-passing signal surpasses the threshold.

2. The system of claim 1, wherein the ball screw comprises a plurality of balls and at least one return tube, the balls pass through the return tube, and the processing device analyzes the operating signal so as to track a ball-passing frequency order, and identifying one said the ball-passing signal to be compared with the threshold according to the ball-passing frequency order, the ball-passing frequency order is associated with a revolution speed of the balls of the ball screw.

3. The system of claim 2, wherein the processing device creates a tracking order, and filters out a noise of the tracking order so as to obtain the ball-passing frequency order, in which the noise refers to a vibration or a sound generated by other than the balls of the ball screw.

4. A method for monitoring preload in a ball screw, the method comprising:
using a detecting device to detect an operating signal of the ball screw that is operating, the operating signal contains information about a rotating speed and a status of the ball screw, the status refers to a vibration or a sound generated by the operating ball screw, in which the ball screw comprises a plurality of balls and at least one return tube the balls pass through the return tube;
using a capturing device to acquire the operating signal;
using a processing device to receive the operating signal, the processing device has a threshold;
using the processing device to perform an order tracking process, which involves analyzing the operating signal so as to track a ball-passing frequency order that is associated a revolution speed of the balls of the ball screw;
using the processing device to perform a ball-passing frequency order analysis, which involves identifying a ball-passing signal according to the ball-passing frequency order; and
using the processing device to determine that the preload of the ball screw has vanished when the ball-passing signal surpasses the threshold, and determine that the preload of the ball screw has not vanished when the ball-passing signal of the processing device has not surpassed the threshold.

5. The method of claim 4, wherein the step of using the processing device to perform the ball-passing frequency order analysis further comprises creating a tracking order and filtering out a noise of the tracking order, so as to obtain the ball-passing frequency order, in which the noise refers to a vibration or a sound generated by other than the balls of the ball screw.
